(19) United States
(12) Patent Application Publication
(10) Pub. No.: US 2016/0145733 A1
(43) Pub. Date: May 26, 2016

(54) INWARD DIFFUSION OF ALUMINUM-SILICON INTO A STEEL SHEET

(71) Applicant: SCHWARTZ GMBH, Simmerath (DE)

(72) Inventor: ROLF-JOSEF SCHWARTZ, SIMMERATH (DE)

(73) Assignee: SCHWARTZ GMBH, Simmerath (DE)

(21) Appl. No.: 14/896,965

(22) PCT Filed: Jun. 23, 2014
(86) PCT No.: PCT/EP2014/063150

§ 371 Date: Dec. 9, 2015

(30) Foreign Application Priority Data
Jun. 25, 2013 (EP) 13173619.1

(51) Int. Cl. C23C 10/28; C23C 10/60; F27D 3/00; F27B 1/00; F27B 1/20; C23C 10/02; C21D 9/46

(52) U.S. Cl. CPC C23C 10/28; C23C 10/02; C23C 10/60; C21D 9/46; F27B 1/005; F27B 1/20; F27D 3/0024

(57) ABSTRACT

The invention relates to a device and to a method to diffuse Al—Si into a surface of an Al—Si-coated steel sheet. First of all, a steel sheet is fed into a furnace that can be heated up to the diffusion temperature and subsequently, it is conveyed contactlessly through the furnace that has been heated up to the diffusion temperature. In this process, the steel sheet is heated up to the diffusion temperature, whereby the Al—Si diffuses into a surface of the steel sheet. Subsequently, the steel sheet with the Al—Si that has diffused into a surface is cooled off at a rate of less than approximately 25K/sec.

The invention relates to a device and to a method to diffuse aluminum-silicon (Al—Si) into a surface of an Al—Si-coated steel sheet, a process in which the diffusion forms a refractory aluminum-silicon-iron alloy.

In the technical realm, many application cases in various sectors of industry call for high-strength sheet metal parts that should nevertheless be lightweight. For example, the automotive industry is striving to reduce the fuel consumption of motor vehicles and to lower the CO₂ emissions while, at the same time, improving passenger safety. For this reason, there is an ever-growing demand for autobody parts that have a favorable strength-to-weight ratio. These parts include especially the A and B pillars, side-impact protection bar in doors, rocker panels, frame parts, bumpers, crossbeams for the floor and roof as well as front and rear longitudinal beams. In modern motor vehicles, the bodyshell with a safety cage is normally made of hardened sheet steel with a strength of about 1,500 MPa.

This is normally achieved by the process of so-called press-hardening. In this process, a sheet steel part is heated up to approximately 800° C. to 1000° C. [1472° F. to 1832° F.] and subsequently shaped and quenched in a cooled mold. As a result, the strength of the part increases by up to a factor of three.

When it comes to process reliability and cost-effectiveness, continuous furnaces have proven their worth for the heat treatment. Here, the metal parts that are to be treated are continuously conveyed through the furnace. As an alternative, chamber furnaces can also be used in which the metal parts are fed in batches into a chamber, heated up there, and subsequently removed again.

When it comes to press-hardening, a fundamental distinction is made between the direct process and the indirect process.

In the indirect process, a blank is stamped out of a steel sheet, cold-worked, and the component that has been pre-shaped in this manner then undergoes the heat treatment. After the heat treatment, the hot component is placed into the press and press-hardened in an indirectly cooled tool. Subsequently, the components are trimmed once again and sand-blasted in order to remove any scaling that might be present.

In the direct process, a blank is likewise stamped out of a steel sheet; however, in this case, no pre-shaping is carried out, but rather the blank is placed directly into the furnace. After the heat treatment, the hot blank is placed into the press and shaped in an indirectly water-cooled tool and, at the same time, press-hardened. Subsequently, the shaped components are trimmed once again if necessary.

For both processes, so-called roller hearth furnaces have proven their worth in terms of process reliability and cost-effectiveness. An example of an alternative furnace design is the walking-beam furnace, in which the metal parts are transported through the furnace by means of walking beams. Multi-deck chamber furnaces are also gaining in significance.

Since the components are pre-shaped for the indirect process, their complex shapes mean that they have to be conveyed through or placed into the furnace chamber on workpiece carriers. Moreover, continuous furnaces for this process are usually fitted with inlet and outlet locks since, for the indirect process, uncoated components have to be heat-treated. In order to avoid scaling of the surface of the component, such a furnace has to be operated with inert gas. These inlet and outlet locks serve to prevent air from entering the furnace. Chamber furnaces for this process can likewise be equipped with a lock. However, with this furnace design, it is also possible to change the atmosphere in the furnace chamber for each cycle. Continuous furnaces for this process have to be equipped with a return system for the workpiece carriers in order to effectuate the circulation of the workpiece carriers. Ceramic conveyor rollers are used in these furnaces. Only the inlet and outlet tables as well as the return conveyors for the workpiece carriers are equipped with metal conveyor rollers.

When it comes to continuous furnaces for the direct process, there is no need to use workpiece carriers. Consequently, the design is somewhat simpler than that of continuous furnaces for the indirect process. Instead of the blanks being conveyed on workpiece carriers, the blanks used in the direct process are laid directly onto ceramic conveyor rollers and conveyed through the furnace. These furnaces can be operated with or without inert gas. Here, too, a standard feature is that the furnace housing is welded so as to be gas-tight. Another advantage of this design is the positive effect that the conveying roller has on the uniform heating up of the metal parts that are to be treated: the stationary rollers that are likewise heated up by the furnace heating system additionally—by means of radiation and heat conduction—heat up the metal parts that are being transported on these rollers and that are thus in contact with them. Moreover, these furnaces can be operated with a much lower input of energy since there are no workpiece carriers that can cool off while they are being returned after having passed through the furnace and therefore would have to be heated up again when they pass through the furnace anew. The direct process is thus preferred when it comes to the use of continuous furnaces.

The metal sheets used in automotive construction are not supposed to rust. Scaling should also be avoided during the working process since, before any further processing, at the latest before the welding or coating processes, such scaling has to be removed, which is both labor-intensive and costly. However, since untreated steel sheets would inevitably develop scaling in the presence of oxygen at the high temperatures required for press hardening, it is common practice to use coated metal sheets and/or to carry out the heat treatment process in the absence of oxygen.

Normally, aluminum-silicon-coated (Al—Si-coated) metal sheets are used for press-hardened components for the automotive industry. The coating prevents the metal sheets from rusting and also prevents the occurrence of scaling of the hot metal sheets during the transfer from the furnace to the press. The Al—Si of the coating diffuses into the steel surface when the blank is heated up to the hardening temperature and it protects the base material against scaling. Examples of base materials that have recently come into use are boron-alloyed quenched and tempered steel grades such as for instance, 22MnB5 (material number 1.5528) or 30MnB5 (material number 1.5531).

A major drawback of direct press-hardening in the roller hearth furnaces described above lies in the fact that the Al—Si-coated blanks are laid directly onto the ceramic conveying rollers, as a result of which strong thermo-chemical reactions occur between the Al—Si coating and the ceramic rollers. Another major disadvantage of the method described above lies in the cycle time since most of the furnace time is utilized to melt the Al—Si on the surface and to diffuse it into the substrate surface so that the desired properties relating to welding, corrosion-protection and coating are achieved.

The rollers that are currently used in roller hearth furnaces are hollow rollers made of sintered mullite (3Al₂O₃.2SiO₂) and solid rollers made of quartz material. The quartz material rollers consist of more than 99% SiO₂ and have an application limit of approximately 1100° C. [2012° F.], but with the drawback that they bend under their own weight at approximately 700° C. to 800° C. [1292° F. to 1472° F.]. Rollers made of sintered mullite can be used under load at temperatures of up to 1350° C. [2462° F.] without significant bending occurring. The major advantage of both materials is their high thermal shock resistance. However, both materials have a very high affinity towards reacting with molten aluminum so as to form different aluminum-silicate or even silicide compounds. Since the coating comprises Al—Si, it passes through a molten phase at about 670° C. [1238° F.] during the heating to the temperature of approximately 930° C. [1706° F.] needed for the diffusion. The briefly melted coating has proven to be very aggressive to the furnace rollers and, under unfavorable circumstances, it destroys them within a few days.

The objective of the invention is to put forward a method and a device with which aluminum-silicon can be diffused into a surface of a steel sheet and whereby a hot-formed sheet steel part can be made from the thus treated sheet steel in a press-hardening process, whereby the above-mentioned drawbacks are avoided.

According to the invention, this objective is achieved by a method having the features of the independent claim 1. Advantageous refinements of the method ensue from the subordinate claims 2 to 8. The objective is also achieved by a device according to claim 9. Advantageous embodiments of the device ensue from the subordinate claims 10 to 16.

The method according to the invention for diffusing Al—Si into a surface of an Al—Si-coated steel sheet comprises the following steps:

first of all, the steel sheet is fed into a furnace that can be heated up to the diffusion temperature and subsequently, it is conveyed contactlessly through the furnace that has been heated up to the diffusion temperature. In this process, the steel sheet is heated up to the diffusion temperature, whereby Al—Si diffuses into a surface of the steel sheet. At the same time, iron from the steel sheet substrate also diffuses into the Al—Si coating on the surface of the steel sheet. A refractory aluminum-silicon-iron alloy is formed on the surface of the steel sheet. Subsequently, the steel sheet is cooled off at a rate of less than approximately 25K/sec so that a ferrite-pearlite structure is formed. This yields a treated steel sheet from which a hot-formed sheet metal part can be made by means of press-hardening in a later process step. For example, in a stamping process, a sheet metal blank is first cut out of the treated soft steel sheet and it can then be heated up to the martensite-formation temperature in a conventional roller hearth furnace for the subsequent press-hardening, without the Al—Si passing through a liquid phase and thus causing a reaction that would damage the rollers of the roller hearth furnace.

In an advantageous embodiment of the method, Al—Si diffuses into both surfaces of a steel sheet that is coated on both sides with Al—Si.

Advantageously, the steel sheet is obtained directly from a first sheet steel coil. The coil shape here is the usual shape in which steel sheets are commercially available.

It has also proven to be advantageous for the steel sheet to be wound into a second sheet steel coil after it has passed through the furnace and has slowly cooled down to a temperature at which a ferrite-pearlite structure is formed. Through the winding procedure, the diffusion of the Al—Si can be uncoupled from the next process step, for instance, the stamping of the blanks, so that the cycle times do not have to be coordinated with each other. The steel sheet pretreated by means of the method according to the invention, however, can alternatively also be immediately further treated, whereby the winding procedure to form a second sheet steel coil can be dispensed with.

In another advantageous embodiment, the steel sheet is heated up to the diffusion temperature in a first furnace section. After the requisite diffusion time has lapsed and after an optional final annealing has been carried out in order to achieve certain desired physical properties, in a second section of the same furnace, after the Al—Si has diffused into a surface of the steel sheet, the steel sheet is cooled down to a temperature at which a ferrite-pearlite structure is formed. In this process, the cooling rate is less than 25 K/sec. This allows the individual blanks to be cut out later on by means of the stamping procedure. For purposes of better handling, the steel sheet can subsequently be quickly cooled further to the handling temperature.

In a particularly advantageous embodiment, the steel sheet is conveyed contactlessly through the furnace on a hot-air cushion. Here, the hot air can likewise be at the diffusion temperature, so that Al—Si can diffuse into both surfaces of the steel sheet. In this process, the steel sheet floats through the furnace contactlessly on the hot-air cushion, thereby ruling out any damaging reaction between the molten Al—Si and the support fixtures such as, for example, rollers or walking beams.

In an alternative embodiment, the steel sheet is conveyed through the furnace in that a tractive force is applied. In this context, the tractive force can be exerted by the take-off means, for instance, a driven second coiler on which the treated steel sheet can be wound to form a coil, in conjunction with a braked first coiler from which the untreated Al—Si-coated steel sheet is unwound from a coil. In this process, the steel sheet follows a catenary line through the furnace, whereby it sags, for example, between the unwinding point of the first coiler and the winding point of the second coiler as a function of the tractive force exerted and as a function of the distance between the unwinding point and the winding point. Here, it is possible to dispense with the device to create a hot-air cushion. However, this cable pull method can also be combined with the hot-air cushion. This is particularly advantageous if, for instance, the length of the furnace has been chosen so as to be longer in order to allow a faster passage through the furnace while keeping the time constant for the diffusion as well as for an optional final annealing, and for the slow cooling at a cooling rate of less than 25 K/sec to a temperature at which a ferrite-pearlite structure is formed. In the case of a furnace with a greater length, the tractive force applied onto the steel sheet has to be increased. In the case of the combination with the hot-air cushion, in contrast, the tractive force can be reduced.

In another particularly advantageous embodiment, the furnace is arranged essentially vertically. Here, the steel sheet is advantageously conveyed through the furnace from the top to the bottom. This conveyance direction has advantages in terms of the temperature management since, in this manner, the first furnace section with the higher diffusion temperature is arranged above the second furnace section with the lower temperature at which a ferrite-pearlite structure is formed. However, it is likewise possible to select the conveyance direction of the steel sheet so that it is from the bottom to the top.

The device according to the invention for the diffusion of Al—Si into a surface of an Al—Si-coated steel sheet is characterized in that the device comprises a furnace which has a first section that can be heated up to the diffusion temperature, whereby the Al—Si-coated steel sheets can be conveyed contactlessly through the furnace. A hot-formed part sheet steel part can be made in a press-hardening process from the steel sheet that has been treated in this manner.

In an advantageous embodiment, the furnace has a device to create a hot-air cushion on which the steel sheet can be conveyed contactless sly through the furnace. Here, the hot air can likewise be at the diffusion temperature, so that Al—Si can diffuse into both surfaces of the steel sheet. In this process, the steel sheet floats through the furnace contactlessly on the hot-air cushion, thereby ruling out any damaging reaction between the molten Al—Si and the support fixtures such as, for example, rollers or walking beams.

In another advantageous embodiment, the furnace has a hot-air nozzle as the device to create a hot-air cushion.

In an alternative embodiment, the furnace has a device to apply a tractive force onto the steel sheet so that it can be conveyed contactlessly through the furnace. In this process, the steel sheet is kept under tension in such a way that it at least does not sag to such an extent that it touches the furnace. The cable pull can also be combined with the hot-air cushion. This is particularly advantageous if the furnace is so long that the steel sheet would sag too far down in spite of the applied tractive force. In this context, the tractive force can also be reduced through the combination of the hot-air cushion and the cable pull so that very little or no tension needs to be exerted onto the steel sheet.

In another particularly advantageous embodiment, the furnace is arranged essentially vertically. In this context, the Al—Si-coated steel sheet can be conveyed contactlessly through the furnace from the top to the bottom, without the need for a hot-air cushion or a cable pull. Nevertheless, this embodiment can also be combined with the application of a tractive force and/or with a hot-air cushion, whereby the hot-air cushion can also be present on both sides of the steel sheet.

Furthermore, it has also proven to be advantageous for the furnace to also have a second furnace section that is arranged downstream from the first furnace section as seen in the direction of conveyance of the steel sheet, whereby, during its passage through the second furnace section at a cooling rate of less than 25 K/sec, the steel sheet can be cooled down to a temperature at which a ferrite-pearlite structure is formed. Owing to the presence of the second furnace section, the steel sheet can be cooled down to such a temperature, whereby the cooling rate of less than 25 K/sec can be maintained with sufficient process reliability. A soft ferrite-pearlite structure is formed in this process, as a result of which the individual blanks can later be cut by means of stamping.

In an advantageous embodiment, the device also has a feed mechanism to feed the steel sheet into the furnace as well as a take-off mechanism to remove the steel sheet from the furnace. In this process, the feed mechanism and the take-off mechanism can apply a tension onto the steel sheet in such a way that the latter does not sag excessively in the case of an essentially horizontal arrangement of the furnace and the tractive force does not exceed the tear resistance of a catenary line.

It has also proven to be advantageous for the feed mechanism to have a first coiler and for the take-off mechanism to have a second coiler. Here, a coil in its usual commercially available form can be clamped onto the first coiler. The second coiler can rewind the pretreated steel sheet as a coil. The second coiler can also be dispensed with if the pretreated steel sheet is to be further processed right away, for instance, if it is to be conveyed to a stamping device. In order to minimize diffusible hydrogen formation, the furnace can be operated at a low dew point of −70° C. to +10° C. [−94° F. to +50° F.], especially of approximately +5° C. to +10° C. [+41° F. to +50° F.].

Additional advantages, special features and practical refinements of the invention ensue from the subordinate claims and from the presentation below of preferred embodiments making reference to the figures.

The figures show the following:

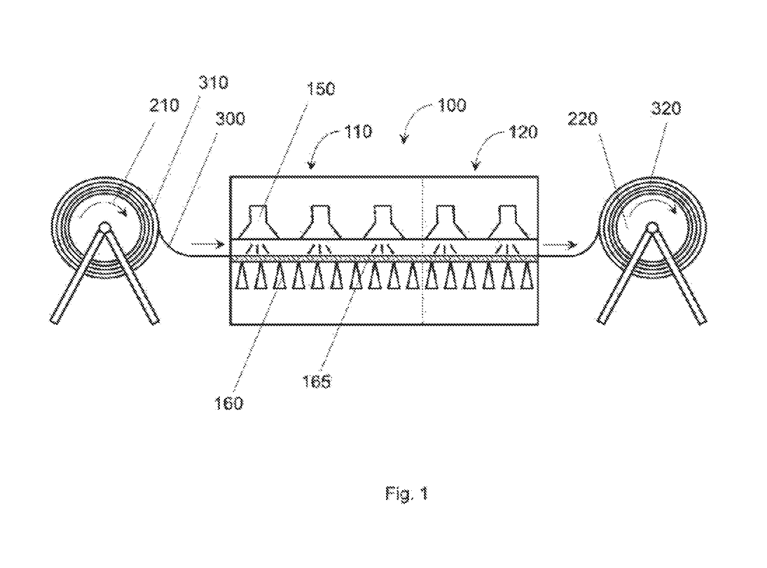

FIG. 1 a device according to the invention, in a horizontal configuration;

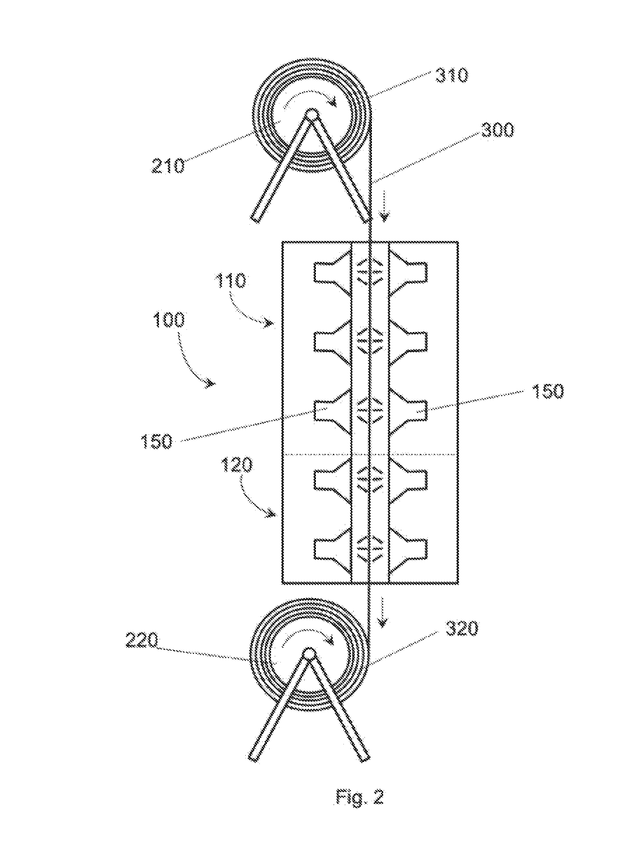

FIG. 2 a device according to the invention, in a vertical configuration.

FIG. 1 shows a device according to the invention, in a horizontal configuration. The device has a first coiler 210 with a sheet steel coil 310 placed onto it. The first coiler 310 consists of a wound-up Al—Si-coated steel sheet 300 in the form of a strip. Rotating the coiler 210 clockwise causes the steel sheet 300 to be unwound and fed into the furnace 100. In this process, a feed mechanism can have guide rollers (not shown here) in addition to the first coiler 210. The furnace 100 has a first section 110 that is heated up to a temperature at which the Al—Si of the coating diffuses into the surface of the steel sheet 300. At the same time, iron diffuses out of the substrate of the steel sheet into the Al—Si. A refractory aluminum-silicon-iron alloy is formed on the surface of the steel sheet. In this process, the furnace is heated up by means of heaters 150 and a hot-air cushion 165 that is created under the steel sheet 300 by means of hot-air nozzles 160. The steel sheet 300 floats on the hot-air cushion through the furnace 100 without touching the latter. Additional support or guide elements such as, for example, rollers or the like, are not necessary. This rules out any damaging reaction between the molten Al—Si and these support and/or guide elements. The heaters 150 are gas burners. However, electric infrared heaters or hot-air heaters, for example, are likewise conceivable. The length of the first furnace section is dimensioned as a function of the rate at which the steel sheet 300 passes through the furnace in such a way that the steel sheet is heated up to the diffusion temperature of, for instance, 930° C. to 950° C. [1706° F. to 1742° F.] and this temperature is maintained for the requisite diffusion time. By the same token, an optional final annealing time is taken into consideration in dimensioning the length of the first furnace section. There is a second furnace section 120 downstream from the first furnace section 110 as seen in the direction of conveyance of the steel sheet. The temperature management in the second furnace section 120 and the length of the second furnace section are dimensioned in such a way that the steel sheet is cooled down at a cooling rate of less than 25 K/sec to the temperature range in which a ferrite-pearlite structure is formed, so that a blank can be subsequently stamped out of the steel sheet.

Downstream from the second furnace section 120, there is a take-off mechanism having a second coiler 220. The second coiler 220 likewise turns in the clockwise direction, as a result of which the pretreated steel sheet is rewound to form a second coil 320. The take-off mechanism can have guide rollers (not shown here) in addition to the second coil 320.

FIG. 2 shows a device according to the invention, in a vertical configuration. The furnace 100 is configured as a tower that is oriented essentially vertically. The steel sheet 300 is conveyed through the furnace 100 from the top to the bottom. Owing to the vertical construction, there is no need for any measures such as the provision of hot-air cushions or cable pulls in order to guide the steel sheet contactlessly all the way through the furnace 100. The conveyance direction from the top to the bottom facilitates the temperature management in the furnace since the cooler second furnace section 120 is situated below the first furnace section 110, which is heated up to the diffusion temperature. Since there is no need for a hot-air cushion 165, heaters 150 are provided on both sides of the furnace 100 in order to ensure a homogenous heating of both surfaces of the steel sheet 300. In the case of the horizontal configuration, these heaters can be in the form of gas burners or hot-air heaters, or else, for instance, in the form of electric radiant heaters.

The guide and take-off mechanisms for the steel sheet 300 are configured analogously to those in the horizontal configuration.

The embodiments shown here constitute merely examples of the present invention and therefore must not be construed in a limiting fashion. Alternative embodiments considered by the person skilled in the art are likewise encompassed by the scope of protection of the present invention.

### LIST OF REFERENCE NUMERALS

100 furnace
110 first furnace section
120 second furnace section
150 heater
160 hot-air nozzle
165 hot-air cushion
210 first coiler
220 second coiler
300 steel sheet
310 first sheet steel coil
320 second sheet steel coil

1. A method to diffuse Al—Si into a surface of an Al—Si-coated steel sheet, whereby a hot-formed sheet steel part can be made from the treated sheet steel in a press-hardening process, characterized by the following steps:
a) the steel sheet is fed into a furnace that can be heated up to the diffusion temperature;
b) the Al—Si-coated steel sheet is conveyed contactlessly through the furnace that has been heated up to the diffusion temperature, a process in which the steel sheet is heated up to the diffusion temperature, and the Al—Si diffuses into a surface of the steel sheet;
c) the steel sheet with the Al—Si that has diffused into a surface is cooled off at a rate of less than approximately 25K/sec to below the martensite-formation temperature.

2. The method according to claim 1,
characterized in that
the steel sheet is coated on both sides with Al—Si and Al—Si diffuses into both surfaces.

3. The method according to claim 1,
characterized in that
the steel sheet is obtained from a first sheet steel coil.

4. The method according to claim 1, characterized in that
the steel sheet is wound into a second sheet steel coil after it has passed through the furnace and has slowly cooled down to the temperature range in which a ferrite-pearlite structure is formed.

5. The method according to claim 1, characterized in that
the steel sheet is heated up to the diffusion temperature in a first furnace section, and, in a second section of the same furnace, after the Al—Si has diffused into a surface of the steel sheet, the steel sheet is cooled down at a cooling rate is less than 25 K/sec to the temperature range in which ferrite-pearlite structure is formed.

6. The method according to claim 1, characterized in that
the steel sheet is conveyed contactlessly through the furnace on a hot-air cushion.

7. The method according to claim 1, characterized in that
the steel sheet is conveyed through the furnace in that a tractive force is applied.

8. The method according to claim 1, characterized in that
the furnace is arranged essentially vertically and the steel sheet is conveyed through the furnace from the top to the bottom.

9. A device to diffuse Al—Si into a surface of an Al—Si-coated steel sheet, whereby a hot-formable and hardenable sheet steel blank can be made from the treated sheet steel in a press-hardening process,
characterized in that
the device comprises a furnace, whereby said furnace has a first section that can be heated up to the diffusion temperature, whereby the Al—Si-coated steel sheet can be conveyed contactlessly through the furnace.

10. The device according to claim 9,
characterized in that
the furnace has a device to create a hot-air cushion on which the steel sheet can be conveyed contactlessly through the furnace.

11. The device according to claim 10,
characterized in that
the furnace has a hot-air nozzle to create a hot-air cushion.

12. The device according to claim 9,
characterized in that
the furnace has a device to apply a tractive force onto the steel sheet so that it can be conveyed contactlessly through the furnace.

13. The device according to claim 9,
characterized in that
the furnace is arranged essentially vertically, whereby the Al—Si-coated steel sheet can be conveyed contactlessly from the top to the bottom.

14. (canceled)

14. The device according to claim 9,
characterized in that
the device also has a feed mechanism to feed the steel sheet into the furnace as well as a take-off mechanism to remove the steel sheet from the furnace.

15. The device according to claim 14,
characterized in that
the feed mechanism has a first coiler and the take-off mechanism has a second coiler.
